(19) United States
(12) Patent Application Publication
(10) Pub. No.: US 2026/0258175 A1
(43) Pub. Date: Sep. 3, 2026

(54) PROCESS FOR PRODUCING PVC AND PVC PRODUCT

(71) Applicant: INOVYN EUROPE LIMITED, Runcorn (GB)

(72) Inventors: Vincent Pierre Francois Marie BODART, Belgrade (BE); Frederic BOSCHET, Jemeppe sur sambre (BE)

(21) Appl. No.: 18/846,946

(22) PCT Filed: Mar. 21, 2023
(86) PCT No.: PCT/EP2023/057210

§ 371 Date: Sep. 13, 2024

(30) Foreign Application Priority Data
Mar. 21, 2022 (EP) 22163327.4

(51) Int. Cl. C08F 220/18; C08F 2/22

(52) U.S. Cl. CPC C08F 220/1804; C08F 2/22

(57) ABSTRACT

A process for producing vinyl chloride containing copolymers includes batch copolymerising in an emulsion polymerisation process, a mixture comprising vinyl chloride monomer (A) and a comonomer (B), wherein a weight ratio of A:B added to the polymerisation process is greater than 10:1 and the corresponding copolymer comprises less than 10 wt % comonomers. The comonomer (B) is added continuously over at least 50% of the reaction time and/or in multiple additions. After the reaction time, the temperature of the reaction mixture is increased and unreacted vinyl chloride is stripped over a period of at least 10 minutes, followed by recovering the vinyl chloride containing copolymer. The present invention also provides a vinyl chloride-n-butyl acrylate copolymer, use of said copolymer in PVC products, and a PVC product comprising a vinyl chloride-n-butyl acrylate copolymer.

### FIELD AND BACKGROUND OF THE INVENTION

The present invention relates to a process for the production of vinyl chloride containing copolymers by emulsion polymerisation.

Polyvinylchloride (PVC) is one of the most important thermoplastic materials on the market today. Given its very good mechanical and physical properties, it is used in a large number of applications.

Several processes are known for the preparation of PVC. For example, PVC may be prepared by suspension polymerisation of vinyl chloride in a suspending liquid and in the presence of a suspending agent. This produces a slurry (or suspension) of PVC particles, typically of the order of 30 to 200 microns particle size. The resulting slurry of PVC is then dried, usually by centrifugation followed by fluid bed drying, to give a porous (i.e. sorbent) PVC. PVC produced by the suspension method is referred to as “S-PVC”. S-PVC can absorb plasticisers to give a dry blend.

PVC can also be produced by what are generally known as paste or emulsion polymerisation processes. Emulsion polymerisation processes may be characterised in that the polymerisation produces a latex of polymer particles of relatively small size compared to the S-PVC process, typically 0.01 to 5 microns. The latex can be dried, for example by spray-drying to produce PVC grains in the form of agglomerates. The dried PVC polymer grains are typically much smaller than the dried particles produced by the suspension PVC processes.

It is known to add additives to PVC to make it suitable for different applications. It is also known to polymerise the vinyl chloride monomer in the presence of a comonomer which gives improved properties. The most common comonomer for PVC is vinyl acetate. A particular further class of comonomers which has found application in PVC are alkyl acrylates or methacrylates.

WO 2014/188971, for example, describes a vinyl chloride-containing copolymer produced by copolymerising 30 to 98 wt % inclusive of an acrylic copolymer with 2 to 70 wt % inclusive of a vinyl chloride monomer, wherein the acrylic copolymer is produced by copolymerizing 100 parts by weight of an alkyl (meth)acrylate monomer with 0.1 to 10 parts by weight inclusive of a polyfunctional monomer.

WO 2015/090657, for example, describes a process for the preparation of a copolymer of a vinyl halide monomer and at least one further monomer B wherein the monomer B is a monomer whose polymer has a Tg lower than that of the polymer produced by polymerizing the at least one vinyl halide monomer. The process comprises a series of process steps by which different amounts of the respective monomers are introduced during the polymerisation process.

Addition of alkyl acrylates can give polymers with improved properties in terms of low gelation temperature i.e. polymers which have a lower gelation temperature, which is advantageous in many applications. However, this can be at the expense of other advantageous or desirable properties, not least viscosity.

### SUMMARY OF THE INVENTION

The present invention relates to copolymers of vinyl chloride with a comonomer, but where the comonomer is present in the final product at relatively low level.

It is an objective of the present invention to provide PVC copolymers which have an improved combination of properties, and in particular with a relatively low temperature of gelation.

In particular, the present inventors have discovered that improved vinyl chloride containing copolymers can be obtained by polymerising vinyl chloride in an emulsion polymerisation process with a comonomer by specific control of the introduction of the comonomer during the process.

Thus, in a first aspect, the present invention provides a process for the production of a vinyl chloride containing copolymer which process comprises:
a. Batch copolymerising in an emulsion polymerisation process, a mixture comprising vinyl chloride monomer (A) and a comonomer (B), wherein:
   i. The weight ratio of A:B added to the polymerisation process is greater than 10:1 and such that the corresponding copolymer comprises less than 10 wt % comonomers,
   ii. The comonomer (B) is added
      1. continuously over at least 50% of the reaction time, or
      2. in multiple separate additions and wherein the initial and final additions are at least 50% of the reaction time apart, or
      3. in a combination of the above,
b. After the reaction time,
   i. increasing the temperature of the reaction mixture and
   ii. stripping unreacted vinyl chloride over a period of at least 10 minutes, and
c. Recovering the vinyl chloride containing copolymer.

### DETAILED DESCRIPTION OF THE INVENTION

The present invention relates to an emulsion polymerisation process. The term “emulsion polymerisation” as used herein, takes the IUPAC definition of “Polymerisation whereby monomer(s), initiator, dispersion medium, and possibly colloid stabilizer constitute initially an inhomogeneous system, resulting in particles of colloidal dimensions containing the formed polymer.”

According to the above definition, and as used herein emulsion polymerisation includes “mini-emulsion” and “micro-suspension” polymerisation processes, again both as defined by IUPAC.

In some embodiments the polymerisation may be a “seeded polymerisation”, which is a polymerisation where previously prepared polymer particles (“seeds”) are added to the process, and polymerisation takes place thereon to form larger particles. This can enable, for example, the preparation of larger particles than can be obtained from a single step polymerisation process and/or the production of bimodal particles with improved properties, such as mechanical stability.

The copolymer comprises vinyl chloride monomer (A) and a comonomer (B). The comonomer (B) is preferably a comonomer which reduces the glass transition temperature of the copolymer compared to a PVC homopolymer. In particular, preferably the vinyl chloride containing copolymer has a glass transition temperature, Tg, of less than 82° C. Such comonomers are known in the art, and in fact are commonly called “soft monomers” because they lower the glass transition temperature. Examples, and comonomers which are therefore particularly preferred for the comonomer (B) in the process of the present invention, include vinyl carboxylates, vinyl ethers, olefins and alkyl (meth)acrylates. Particularly preferred comonomers (B) are vinyl carboxylates, particularly vinyl acetate, and alkyl (meth)acrylates.

Additional comonomers may be present in the polymerisation, either additional “soft monomers” of the types noted above, or other comonomers. However, in all embodiments of the first aspect of the present invention it is required that the corresponding copolymer comprises less than 10 wt % comonomers. Thus, where more than one comonomer is present then the total amount of the comonomers in the produced copolymer must still be less than 10 wt %.

In a preferred embodiment the comonomer (B) is an alkyl (meth)acrylate. The term “alkyl (meth)acrylate” is used herein as shorthand to refer to alkyl acrylates and alkyl methacrylates. For example butyl (meth)acrylate refers to butyl methacrylate and butyl acrylate.

In preferred embodiments the comonomer (B) is an alkyl acrylate. Nevertheless, where described below it should be considered that the embodiments of the invention, even where reference is made solely to acrylates, may equally be applied to the equivalent methacrylate and also to any other comonomers unless the context clearly indicates otherwise.

The preferred alkyl (meth)acrylates comprise a C1 to C10 alkyl group. Preferred alkyl groups comprise C₂ to C₈ alkyls. Particularly preferred alkyl (meth)acrylates according to the present invention are alkyl acrylates rather than alkyl methacrylates. Particularly preferred alkyl acrylates for use as comonomers according to the present invention are ethyl acrylate, ethylhexyl acrylate, t-butyl acrylate and n-butyl acrylate, with n-butyl acrylate being most preferred.

A particular feature of the first aspect of the present invention is that the vinyl chloride containing copolymer produced comprises less than 10 wt % comonomers.

The term “copolymer” as used herein encompasses products with a single comonomer (e.g. vinyl chloride with n-butyl acrylate), but also products with two or more comonomers (e.g. vinyl chloride with n-butyl acrylate and a further comonomer). A product comprising vinyl chloride and two comonomers may also be referred to as a terpolymer, for example, but such is included within the definition of copolymer as used herein.

Where there is a sole comonomer, such as n-butyl acrylate, then this means that the copolymer comprises less than 10 wt % of this comonomer (with respect to total monomers). Where additional comonomers are present then this means less than 10 wt % in total of all comonomers.

In general, the comonomer content of the product may be determined by any suitable technique. One suitable technique, and which is preferred for the purposes of the present invention is the use of 1H Nuclear Magnetic Resonance (NMR).

Preferably the copolymer comprises at least 1 wt % comonomers, such as at least 2 wt % comonomers, and most preferably at least 3 wt % comonomers. Preferably the copolymer comprises less than 9 wt % comonomers, such as less than 8 wt % comonomers, and more preferably less than 7 wt % comonomers.

In preferred embodiments where the comonomer (B) is an alkyl (meth)acrylate, preferably the copolymer comprises at least 1 wt % alkyl (meth)acrylate, such as at least 2 wt % alkyl (meth)acrylate, and most preferably at least 3 wt % alkyl (meth)acrylate. Preferably the copolymer comprises less than 9 wt % alkyl (meth)acrylate, such as less than 8 wt % alkyl (meth)acrylate, and more preferably less than 7 wt % alkyl (meth)acrylate.

In embodiments, the copolymer may preferably comprise 3 to 7 wt % alkyl (meth)acrylate.

In other embodiments, in particular where the copolymer is produced by microsuspension polymerisation, the copolymer may preferably comprise 4 to 8 wt % alkyl (meth)acrylate. This range has been found to produce polymers with low gelation temperature and low viscosity.

The above ranges in alkyl (meth)acrylate content apply where the alkyl (meth)acrylate is the sole comonomer or where other comonomers are present. (And where two or more alkyl (meth)acrylates are present then thee above ranges apply to the total alkyl (meth)acrylate present.)

Where the comonomer (B) is an alkyl (meth)acrylate, typical additional comonomers, when present, might include a second alkyl (meth)acrylate or another suitable comonomer. Examples of other comonomer which might be used include (meth)acrylic acid, maleic anhydride, vinyl acetate, other monomers containing carboxylate group (such as diallyl phthalate, allyl methacrylate and diallyl maleate discussed further below), acrylamide and derivatives, vinylidene chloride, and allyl and vinyl ethers.

In some preferred embodiments there may be present in the polymerisation two alkyl (meth)acrylates, particularly two alkyl acrylates. For example, the polymerisation may comprise a mixture of vinyl chloride monomer (A) and at least two alkyl (meth)acrylate comonomers, and preferably two alkyl acrylate comonomers.

A particularly preferred combination comprises use of both n-butyl acrylate and ethylhexyl acrylate as comonomers.

In all embodiments where one or more further comonomers are present in addition to comonomer (B), a particularly preferred class of further comonomer which can be present comprises a crosslinker or chain extender monomer. Such monomers are well-known in the art for use as comonomers with vinyl chloride. Preferred examples include diallyl phthalate, allyl methacrylate, diallyl maleate, trimethylol propane diallyl ether and tri- or di-ethylene glycol divinyl ether, among others.

The weight ratio of A:B added to the polymerisation process is greater than 10:1 and such that the corresponding copolymer comprises less than 10 wt % comonomers. For avoidance of doubt, this “weight ratio” refers to the total amount of A compared to the total amount of B added during the polymerisation, whenever added.

A key feature of the present invention is that the comonomer (B) is added at different times throughout the polymerisation. Thus, the comonomer is added
1. continuously over at least 50% of the reaction time, or
2. in multiple separate additions and wherein the initial and final additions are at least 50% of the reaction time apart, or
3. in a combination of the above.

In relation to the use of an alkyl (meth)acrylate as a comonomer, for example, the alkyl (meth)acrylate tends to react faster than the vinyl chloride. The same is the case also for a number of other comonomers suitable for use as comonomer (B). For at least this reason, but also since in all embodiments the comonomer (B) is only present in the final copolymer at a relatively low level, adding it at multiple stages ensures that the copolymer's composition is produced more uniformly throughout the polymerisation process, giving the product a more homogeneous structure. Without wishing to be bound by theory this is also believed to be linked to the improved properties obtained.

(The products obtained by the present invention are considered to have the comonomer more evenly distributed throughout the bulk of the polymer particle due to the requirements on when the comonomer is added. This can be contrasted with products obtained when comonomer is present initially but not added “later” in the polymerisation, where the majority of the comonomer is then found in the core of the particle, or where comonomer is only added at the later stages of polymerisation, not initially, where the comonomer is then found in the outer layers of the product.)

As used here, the “reaction time” is the total time as measured from the initiation of the polymerisation until either (i) a step is taken to stop the reaction and/or (ii) until the reaction pressure reduces due to the exhaustion of vinyl chloride.

In particular, in a typical batch emulsion polymerisation process, a stirred, temperature-controlled, pressure resistant reaction vessel, also called an autoclave, is filled with monomers, dispersion medium (typically water) and a stabiliser. It is important to remove the oxygen (as this is a radical scavenger) from the autoclave and reaction medium. The vinyl chloride monomer is immiscible in the water, and takes the form of droplets of vinyl chloride dispersed in the reaction medium and is also present as a vapour phase above the emulsion. The polymerisation reaction temperature is typically in the range of 40-80° C., particularly 45-55° C. (The reaction is exothermic, and the temperature is controlled by removing the heat of reaction at the rate it is produced). A pressure arises due to the vapour pressure of vinyl chloride.

Typically such processes may react for several hours, such as 4 to 8 hours, during which time the conversion of vinyl chloride monomer and other comonomers increases. The reaction pressure is generally fairly uniform for most of the reaction, although small variations, typically “spikes” in pressure, may take place as monomers or other components are added if they are added during the process. At some stage, the vinyl chloride monomer starts to be exhausted in the liquid phase, and the amount of vinyl chloride in the vapour phase becomes insufficient to maintain the saturation vapor pressure. This is observed in the reaction profile by the appearance of a steady decline in reactor pressure.

According to the present invention, and as is commonly used in the art, this pressure drop marks the end of the “reaction time” (unless the reaction is stopped before this, for example by addition of a termination or “killer” agent).

The typical reaction time will depend on the process conditions, but will be well-known to the person skilled in the art from previous experience of their specific system/conditions. Typically the reaction time is between 4 and 8 hours.

It should be noted that further copolymerisation (of vinyl chloride and comonomers) can still take place after this time, not least during step (b) in the present invention as will be discussed further. Nevertheless, for the purposes of the present invention any such subsequent time is not part of the “reaction time”.

In the first option in the present invention, which is preferred, the comonomer is added continuously over at least 50% of the reaction time.

For avoidance of doubt, the addition according to this requirement may be stopped or interrupted temporarily, as long as there is a continuous addition over at least 50% of the total reaction time. For example, with a reaction time of 4 hours, comonomer (B) may be added continuously for the first 60 minutes of the reaction time, stopped for 15 minutes, then added continuously for the next 60 minutes, stopped for another 15 minutes, and then added continuously for another 60 minutes, before being stopped for the final 30 minutes (before the pressure drop is observed). The total time for continuous addition in this example is then 3 hours, which is 75% of the reaction time of 4 hours. Most preferably the comonomer (B) is added continuously to the process over at least 75% of the reaction time.

In the second option in the present invention, the comonomer (B) is added in multiple additions and wherein the initial and final additions are at least 50% of the reaction time apart. It is preferred that the initial and final additions are at least 75% of the reaction time apart. There may in this option be at least 2 separate additions, preferably at least 3 and more preferably at least 4 separate additions of comonomer. Each addition may comprise a single (i.e. “one off” or “instantaneous”) injection or may comprise addition over a longer period of time, such as 5 to 10 minutes or longer. (Where this is the case for one or both of the initial and final additions, then reference to the initial and final addition being a certain percentage of the reaction time apart refers to the start of the initial addition and/or the end of the final addition.)

In preferred embodiments, the addition of comonomer (B) is started no later than 1 hour after the start of the reaction time and/or no later than when 25% of the reaction time has elapsed.

(In relation to the option that addition of comonomer (B) is started no later than when 25% of the reaction time has elapsed, it may be noted that this requirement inherently met in options where:
(i) the comonomer (B) is added continuously to the process over at least 75% of the reaction time, and
(ii) the comonomer (B) is added in multiple additions and where the initial and final additions are at least 75% of the reaction time apart.)

In absolute terms it is preferred that addition of comonomer (B) is started no later than 30 minutes after the start of the reaction time (i.e. initiation of the reaction), more preferably no later than 10 minutes after the start of the reaction time.

In addition, or alternatively, it is preferred that addition of comonomer (B) is started no later than no later than when 10% of the reaction time has elapsed, and more preferably no later than when 5% of the reaction time has elapsed.

Most preferably, comonomer B is present (whether added continuously or via an initial addition) at initiation of the reaction.

Where the comonomer (B) is added in multiple additions then it is preferred that it is added in individual additions which may be relatively evenly distributed throughout the reaction time. For example, in a process with a reaction time of 4 hours and with 4 additions, the additions could be made at the start of the reaction, and then at approximately 1 hour, 2 hours and 3 hours.

In a third option a combination of options 1 and 2 may be used. For example, one option which falls under the second option is that the comonomer may be added in multiple additions where one or more of the additions are continuous. If the total of one or more continuous additions is more than 50% of the total reaction time then both options 1 and 2 can be met.

In all options, it is preferred that no comonomer (B), and preferably no other monomer, is added during the final 15 minutes the reaction time. In particular, during this time the reaction is allowed to consume any comonomer (B) remaining in the reaction medium.

In relation to the vinyl chloride, this may also be added continuously or in separate additions during the polymerisation process. Typically, and preferably, however, the majority of the vinyl chloride to be added, and preferably at least 70% of the vinyl chloride is present at the start of the reaction. As an example, 80% of the total vinyl chloride may be present at the start of the reaction, and two additions of about 10% each of the total are made during the reaction time.

The above additions relate to the comonomer (B) and vinyl chloride additions. Where a further comonomer is added this may be added in any suitable manner/over any suitable timescale. Any additional comonomers may, for example, be added solely or predominantly at the beginning of the reaction in a similar manner to the vinyl chloride monomer (including before initiation). Alternatively they may be added continuously or in several separate additions spaced throughout the reaction time, in a similar manner to the comonomer (B).

The process of the present invention comprises, after the reaction time, a step (b) which comprises:
i. increasing the temperature of the reaction mixture and
ii. stripping unreacted vinyl chloride over a period of at least 10 minutes.

Step (b) takes place after the “reaction time”. In particular, step (b) in the present invention is considered to start immediately at the end of the reaction time (i.e. the end of the reaction time constitutes the start of step (b)), although it is not critical that steps (i) or (ii) are themselves started immediately at the start of step (b). Typically, and very preferably, no monomers are added to the reaction mixture during step (b).

In step (i), the temperature of the reaction mixture is increased. Typically this can be achieved by reducing the cooling being applied and allowing the heat from the remaining polymerisation which is taking place to heat up the process. However, additional heating can be applied if desired. The temperature may be increased by at least 10° C., such as at least 20° C. compared to the temperature at the end of the reaction time. Typically the temperature may be increased in this step up to a temperature of 70-85° C., and preferably 75-80° C. This can be compared to a typical polymerisation temperature of 40-70° C., particularly 45-55° C.

The temperature is typically increased over a period of at least 10 minutes, such as 15 minutes to 1 hour.

The increase in temperature acts to increase the conversion of unreacted monomers, particularly of vinyl chloride. Typically the conversion after this step is in excess of 90% for vinyl chloride monomer.

In step (ii), any unreacted vinyl chloride is stripped from the mixture over at least 10 minutes. This step generally takes place after step (i), and in preferred embodiments of the present invention may be achieved by releasing any remaining pressure in the reactor to vent the contents, whilst maintaining an increased temperature, particularly at the temperature of step (ii), causing vaporisation and removal of unreacted vinyl chloride from the emulsion. A vacuum may be applied to aid the removal in this step, and in particular so that the boiling point of the continuous medium (water) is reached.

The vented components can be collected for reuse.

In other embodiments, however, the reactor contents may be discharged from the reactor and transferred to a separate vessel for the stripping step. The external stripping process can then be either batch or continuous.

Stripping is preferably performed for at least 20 minutes, such as 20 minutes to 1 hour.

In preferred embodiments, step (b) further comprises a step of addition to the polymerisation reaction medium of an alkali metal hydroxide. Sodium hydroxide is most preferred.

The alkali metal hydroxide may be added at the start of step (b), for example as soon as the reaction time is ended. Alternatively, the increase in temperature in step (i) may be started first, and the alkali metal hydroxide or other compound added during the increase in temperature, or even at the end of the temperature increase.

(In other embodiments alkali metal hydroxide may be added after step (b), such as before venting or at any time prior to the reactor discharge.)

Step (b) in total typically takes between 30 minutes and 2 hours. In general, it is desired to minimise the time for step (b) so that a further batch reaction can be performed as soon as possible, but this must be balanced against the desire to remove residual monomers.

The stripped vinyl chloride copolymer is then recovered from the process. Typically the product is recovered from the reactor as a latex of the copolymer, and is dried, for example by spray-drying as is conventional in the art. The latex can also be dried using any available technique known in the art for drying latexes (including coagulation). The final product, after drying, typically contains less than 1 ppm vinyl chloride monomer and less than 100 ppm comonomers.

More generally, the present invention provides a process for the production of a vinyl chloride containing copolymer which is a batch copolymerisation in an emulsion polymerisation process. Such processes are well-known and some typical details have already been described. Generally, other than the requirements of the present invention and as set out above, including in particular for the addition of the comonomer during the reaction, the polymerisation process may be operated according to any such known batch emulsion polymerisation process conditions, including, for example, in any suitable reactor type for such polymerisations. As also already noted, such conditions can include “conventional” emulsion polymerisation process conditions, and also those more commonly referred to as “mini-emulsion” and “micro-suspension” polymerisation processes, both well known in the art. The polymerisation may, for example, use initiators, stabilisers, buffers and other components typically added in such reactions. Examples of suitable conditions and components can be found, for example, in WO 2013092730 A1, WO 2015090657 A1 and EP 2960271 A1.

As already noted, a particularly preferred comonomer (B) for the process of the first aspect of the present invention is n-butyl acrylate.

In a second aspect there is provided a vinyl chloride-n-butyl acrylate copolymer, preferably produced according to the process of the first aspect of the present invention.

In this second aspect the preferred copolymer is as preferred for the copolymer in the first aspect e.g. in terms of comonomer content, other comonomers which can be present.

For example, the copolymer preferably comprises less than 10 wt % n-butyl acrylate, preferably less than 9 wt % n-butyl acrylate, such as less than 8 wt % n-butyl acrylate, and more preferably less than 7 wt % n-butyl acrylate. Preferably the copolymer comprises at least 1 wt % n-butyl acrylate, such as at least 2 wt % n-butyl acrylate, and most preferably at least 3 wt % n-butyl acrylate, such as at least 4 wt % n-butyl acrylate.

In embodiments, the copolymer may preferably comprise 3 to 7 wt % n-butyl acrylate.

In other embodiments, in particular where the copolymer is produced by microsuspension polymerisation, the copolymer may preferably comprise 4 to 8 wt % n-butyl acrylate. This range has been found to produce polymers with low gelation temperature and low viscosity.

In a first embodiment of this second aspect of the invention, the vinyl chloride-n-butyl acrylate copolymer:
A) has a plastisol rheology measured at 23° C. 1.4 s⁻¹ according to ISO 3219 and ISO/TC61/N4710 of 24 Pa·s or less, and
B) has a gelation temperature, measured as the temperature at which a viscosity of 10,000 Pa·s is reached, of 76° C. or less,
wherein the plastisol rheology and gelation temperature are measured on a plastisol formed by mixing the copolymer with 55 parts per hundred of diisononyl phthalate.

In particular the copolymers of this embodiment exhibit a favourable combination of low plastisol rheology and low gelation temperature. They can also exhibit low Tg (glass transition temperature) and good thermal stability. This embodiment in particular relates to copolymers produced by microsuspension polymerisation processes, where low gelation temperature and plastisol rheology are both desirable. (It should be noted that microsuspension and emulsion grades of vinyl chloride copolymers generally have different properties and are generally used for different applications. This embodiment relates to microsuspension grades due to the requirement on viscosity (plastisol rheology), whereas an emulsion grade would have a viscosity higher than 24 Pa·s under the measurement method noted for this embodiment (55 phr diisononyl phthalate).)

It is known that adding n-butyl acrylate can reduce gelation temperature compared to the corresponding vinyl chloride homopolymer. However, the addition of n-butyl acrylate can also increase the plastisol rheology, which is undesirable. It has been found that addition of n-butyl acrylate by the process of the present invention leads to even further reductions in gelation temperature than addition of n-butyl acrylate at the beginning of the polymerisation, but with lesser increases, and in some cases even decreases, compared to the homopolymer, in the plastisol rheology.

In this first embodiment the copolymer may comprise at least 3 wt % but less than 15 wt % n-butyl acrylate, for example at least 3 wt % but less than 10 wt % n-butyl acrylate. Preferably in this first embodiment the copolymer may comprise 4 to 8 wt % n-butyl acrylate.

Preferably, in this first embodiment, the plastisol rheology measured at 23° C. 1.4 s⁻¹ according to ISO 3219 and ISO/TC61/N4710 is 23 Pa·s or less, such as 22 Pa·s or less, or 21 Pa·s or less. In some embodiments the plastisol rheology measured at 23° C. 1.4 s−1 according to ISO 3219 and ISO/TC61/N4710 is 20 Pa·s or less, for example 15 Pa·s or less, or even 10 Pa·s or less. Typically the plastisol rheology is at least 2, such as at least 3 Pa·s.

Preferably, the gelation temperature, measured as the temperature at which a viscosity of 10,000 Pa·s is reached, is 75° C. or less, such as 74° C. or less or 73° C. or less. In some embodiments the gelation temperature is 72° C. or less, such as 70° C. or less, such as 65° C. or less or 60° C. or less. Typically the gelation temperature is at least 50° C.

(For avoidance of doubt, both of the above are still measured on a plastisol formed by mixing the copolymer with 55 parts per hundred of diisononyl phthalate as already defined.)

As will be known to the person skilled in the art, the plastisol rheology should be measured soon after mixing with the plasticiser to minimise the effects of aging on the result. In the present invention the rheology is measured within one hour after the mixing of the copolymer with the diisononyl phthalate. Preferably the gelation temperature is also measured within one hour after the mixing of the copolymer with diisononyl phthalate.

In a second embodiment of this second aspect of the invention, the vinyl chloride-n-butyl acrylate copolymer:
A) has a plastisol rheology measured at 23° C. 1.4 s⁻¹ according to ISO 3219 and ISO/TC61/N4710 of 20 Pa·s or more, and
B) has a gelation temperature, measured as the temperature at which a viscosity of 10,000 Pa·s is reached, of 76° C. or less,
wherein the plastisol rheology and gelation temperature are measured on a plastisol formed by mixing the copolymer with 100 parts per hundred of diisononyl phthalate.

In particular the copolymers of this embodiment exhibit a favourable combination of high plastisol rheology and low gelation temperature. This embodiment in particular relates to copolymers produced by emulsion polymerisation processes, where low gelation temperature but high plastisol rheology are both desirable. (It should be noted that higher viscosity PVC resin are produced by emulsion copolymerisation rather than microsuspension, and that the measurements above are therefore performed, as is typical in the art, with higher levels of plasticiser than the equivalent measurements on microsuspension grades in the first embodiment. Despite the higher levels of plasticiser, the plastisol rheology value is higher than in the first embodiment.)

As with microsuspension grades, it is known for emulsion grades that adding n-butyl acrylate can reduce gelation temperature compared to the corresponding vinyl chloride homopolymer. However, the addition of n-butyl acrylate at the beginning of the polymerisation when producing emulsion grades can cause significant reductions in the plastisol rheology, which is undesirable in such grades. It has been found that addition of n-butyl acrylate by the process of the present invention still leads to desirable reductions in gelation temperature but with lesser decreases in the plastisol rheology for a particular reduction in gelation temperature. This allows a copolymer with similar gelation temperature and higher plastisol rheology. (Alternatively, the n-butyl acrylate addition can be adjusted to provide an optimum balance in gelation temperature and plastisol rheology.)

In this second embodiment the copolymer may comprise at least 3 wt % but less than 15 wt % n-butyl acrylate, for example at least 3 wt % but less than 10 wt % n-butyl acrylate. Preferably in this second embodiment the copolymer comprises at least 4 wt % n-butyl acrylate, such as 4 to 8 wt % n-butyl acrylate.

Preferably, in this second embodiment, the plastisol rheology measured at 23° C. 1.4 s⁻¹ according to ISO 3219 and ISO/TC61/N4710 is 25 Pa·s or more, such as 30 Pa·s or more, 40 Pa·s or more or even 50 Pa·s or more. The plastisol rheology measured at 23° C. 1.4 s⁻¹ according to ISO 3219 and ISO/TC61/N4710 is typically 140 Pa·s or less, for example 100 Pa·s or less.

Preferably, the gelation temperature in this second embodiment, measured as the temperature at which a viscosity of 10,000 Pa·s is reached, is 75° C. or less, such as 74° C. or less or 73° C. or less. In some embodiments the gelation temperature is 72° C. or less. Typically the gelation temperature is at least 50° C. More preferably the gelation temperature is at least 64° C., such as at least 68° C.

(For avoidance of doubt, both of the above are still measured on a plastisol formed by mixing the copolymer with 100 parts per hundred of diisononyl phthalate as already defined, and as already noted for the first embodiment the rheology, and preferably the gelation temperature, are measured within one hour after the mixing of the copolymer with the diisononyl phthalate.)

The copolymers of the second embodiment may, as is typical for emulsion grades, be formed of primary particles having a particle size distribution with a peak at a diameter of less than or equal to 1.5 microns and where the peak width at half height is less than 50% of the particle size of the peak. Typically, the peak of the particle size distribution may be at a diameter of less than or equal to 1 micron, such as at less than or equal to 0.5 microns, less than or equal to 0.4 microns, and even less than or equal to 0.2 microns. Typically, the peak of the particle size distribution may be at a diameter of 0.01 microns or larger, such as 0.05 microns or larger.

(In contrast, copolymers according to the first embodiment/microsuspension copolymers, may have a peak in the particle size distribution at a diameter up to 5 microns.

They generally have a particle size distribution with a broader peak width i.e. with a peak width at half height which is more than 50% of the particle size of the peak.)

It has also been found that the copolymers of the second embodiment have an improved gloss. In particular, the copolymers of this second embodiment may have a gloss, measured according to ISO 2813, of at least 75GU (gloss units). Preferably, the gloss is at least 80GU. In some embodiments the gloss may be at least 85GU. Typically the gloss may be up to 97GU.

In preferred embodiments, applicable to both the first and second embodiments above, the copolymer may have a glass transition temperature (Tg), as determined by Differential Scanning calorimetry (DSC), of 80° C. or less, such as 79° C. or less or 78° C. or less. In some embodiments Tg is 75° C. or less. Typically the Tg is at least 64° C., such as at least 68° C., and most preferably at least 70° C.

Because of their combinations of properties the copolymers produced by the first aspect of the present invention or the copolymers according to the second aspect of the present invention are particularly useful in a number of common PVC applications. This includes use as flooring materials, such as floor coverings and tiles, automotive underbody coating, adhesive and sealant materials, and artificial leather materials.

Thus, in a third aspect there is provided use of a vinyl chloride-n-butyl acrylate copolymer produced according to the process of the first aspect, and/or being the vinyl chloride-n-butyl acrylate copolymer of the second aspect, as a flooring material, an automotive underbody coating, adhesive and sealant material or an artificial leather material.

In a fourth aspect there is provided a PVC product comprising a vinyl chloride-n-butyl acrylate copolymer produced according to the process of the first aspect, and/or being the vinyl chloride-n-butyl acrylate copolymer of the second aspect, which PVC product is a flooring material, an automotive underbody coating, adhesive and sealant material or an artificial leather material.

In a preferred embodiment of these third and fourth aspects, a copolymer according to the first embodiment of the second aspect of the present invention may be used for/a part of a flooring material.

In another preferred embodiment of these third and fourth aspects, a copolymer according to the second embodiment of the second aspect of the present invention may be used for/a part of an automotive underbody coating material.

The present invention can be illustrated by the following Examples.

### EXAMPLES

### Measurement Methods

The following methods are used in the present Examples. Unless otherwise specified, where corresponding parameters are found in the claims or general description of the present invention then the values of such parameters are those as would be determined using these methods.
Primary particle sizes distribution of the polymer latexes were measured by photosedimentometry using an equipment from CPS Instruments Inc. The results are expressed as the size at the top of each peak (μm) and the proportion of each peak (%).
The percentage of monomers in the polymer and the percentage of acrylate were calculated from the spectra of 1H Nuclear Magnetic Resonance (NMR) obtained in a Brucker 500 MHz equipment using deuterated chloroform (CDCl₃) or deuterated tetrahydrofuran (THF-d8) as solvents.
The thermal stability was evaluated using the procedure described in the ISO 182-3: based on the detection of the hydrogen chloride and any acidic products evolved at 180° C. The equipment used was a 763 PVC Thermomat from Metrohm. The measurement was done on 0.5 g of PVC resin. The flow of nitrogen is 7 L/h. The thermal stability time (expressed in minutes) is defined as the time required for the reaction of dehydrochlorination at the temperature of 180° C. to lead to a conductivity of 50 μS/cm in a measuring cell containing ultrapure water.
The glass transition temperature was determined by Differential Scanning calorimetry (DSC). The equipment used is a Pyris 1 from Perkin Elmer with a nitrogen flow of 30 mL/min at all times. The sample (20 mg) is stabilized at −5° C. for 5 minutes then heated to 170° C. at 20° C./min, cooled at −5° C. at 20° C./min, hold 15 minutes at −5° C. and then heated to 170° C. at 20° C./min. During this second heating, the glass transition is measured according to standard methods.
The plastisol rheology was measured within 1 hour after mixing with either 55 or 100 phr DINP (diisononyl phthalate) to form a plastisol and then using an Haake Rheostress 1 rotational rheometer at 23° C. between 1.4 and 1000 s⁻¹ according to ISO 3219 and ISO/TC61/N4710. (55 phr was used in Comparative Examples A-C and Examples 1-6, and 100 phr in Comparative Examples D and E, and Examples 7-8.)
Gelation curves were obtained of a plastisol using an ARES rotational rheometer from TA instrument. The experiment consists of an oscillation temperature ramp at a constant angular frequency of 1 rad/s from 25 to 150° C. at 3° C./min. The obtained curve displays the complex viscosity versus the temperature. The value reported as an indication of the gelation is the temperature at which a viscosity of 10,000 Pa·s is reached.
The gloss of a PVC film was measured according to ISO 2813. The gloss was measured on the side of the film that was not in contact with the release paper substrate. The apparatus used is a Dr Lange REFO 3 using calibration standard LZM 151 (60° measurement gloss of 94.5 GU) and a matte black plate under the transparent films.

### Comparative Examples A-C and Examples 1-6

These examples illustrate polymerisation under microsuspension conditions.

### Comparative Example A

In this example vinyl chloride in polymerised under microsuspension conditions, in the absence of comonomer.

In particular, in a premixer autoclave with a capacity of 15 L and equipped with an agitator and a double jacket, 2.7 kg of water, 79.9 g of a 298 g/kg aqueous solution of sodium dodecylbenzene sulfonate, 4.15 g of dilauryl peroxide (99.4%), 5.2 g of dimyristyl peroxydicarbonate (95.4%), 8.9 g of dioctyladipate (100%) and 0.03 g of butylated hydroxyanisole (100%) were added and mixed together at 50 rpm.

In the polymerisation reactor also with a capacity of 15 L and equipped with an agitator and a double jacket, 2.7 kg of water, 1.8 g of sodium carbonate (100%), 119.9 g of a 298 g/kg aqueous solution of sodium dodecylbenzene sulfonate, and 645.8 g of a 384.1 g/kg aqueous solution of small PVC seed of size 130 nm were added and mixed together at 50 rpm.

Both reactors were linked together and closed to the atmosphere, a cycle of a vacuum followed by a nitrogen purge was applied, and finally a vacuum was applied and the agitation speed was increased to 250 rpm and 110 rpm for the premixer autoclave and the polymerisation reactor, respectively. Afterwards, 1985 g and 2977 g of vinyl chloride were loaded to the premixer autoclave and the polymerisation reactor, respectively.

A step of agitation of 30 minutes was maintained to ensure the mixing of all raw materials. Afterwards, the premixer autoclave agitation speed was reduced to 50 rpm and the premixer was connected to 2-stage high pressure homogenizer, previously put under vacuum and the mixture was recirculated 5 minutes with the two stages pressures at 120 bars and 40 bars before transferring the mixture to the polymerisation autoclave.

Then, to rinse the premixer autoclave, and ensure the transfer of all reagents, 1 L of water was added to the premixer autoclave, agitated 3 minutes and transferred to the polymerisation autoclave.

Upon completion of the transfer from the premixer autoclave, the reactor temperature was raised to reach the polymerisation temperature (Tpol) of 49° C. Once Tpol was reached, this defined the beginning of the polymerisation (t0).

During the polymerisation, 2 additional injections of 496 g of vinyl chloride were introduced in the autoclave at t0+2h00 and t0+3h00.

The reaction proceeds until a pressure drop is detected (−1 bar). In this specific Comparative Example the pressure drop was observed at/the reaction time was 7 hours 48 minutes.

(It can be noted that under these conditions the pressure drop is typically observed at/the reaction time is above 7 hours, and typically between 7 and about 8 hours. This was generally case in the Examples performed under microsuspension conditions herein, although reaction times slightly higher than 8 hours were seen in some Examples with continuous addition of n-butyl acrylate. Without wishing to be bound by theory this is believed to be due to the presence of a small amount of polymerisation inhibitor which is added to n-butyl acrylate to maintain stability in storage, but which can slow the reaction rate in use. In all of Examples 1-6 which are reported below, however, reaction time was over 7 hours and n-butyl acrylate was added for over 75% of the reaction time.)

After the pressure drop was detected the temperature of the polymerisation medium was increased up to 80° C. It was then possible to evacuate (with injection of 3.0 g of a commercial antifoam) and strip the residual vinyl chloride from the autoclave. After stripping (25 minutes) the autoclave was cooled down to room temperature and drained.

The solid content of the latex (or latex density) and pH were measured. The latex was filtered through a sieve with a mesh size of 1 mm. The latex was dried on a spray dryer and the obtained resin was sieved and milled according to standard procedures. For the spray dryer, the inlet temperature is 160° C. and the outlet temperature is 60° C. The obtained resin was then milled in a Kolloplex 160Z (pin mill) at maximum intensity (14000 rpm).

The latex obtained had a pH of 9.1, a solid content of 48% and constituted of particles of 0.75 μm (87.3%) and 0.17 μm (12.7%).

The resin has a thermal stability of 28.2 minutes. The plastisol rheology indicated an eta 1.4 of 7.62 Pa·s. From the gelation curve, the viscosity of 10 kPa·s was reached at 84.3° C., while DSC indicated a Tg of 85.9° C.

### Comparative Example B

The procedure of Comparative Example A was repeated except that, in addition, 300.7 g of n-butyl acrylate was added to the premixer at the beginning of the process (during the first step, prior to connection to the polymerisation reactor). (Vinyl chloride was still added in a staged manner as described for Comparative Example A.)

The latex obtained had a pH of 8.9, a solid content of 46.6% and constituted of particles of 0.71 μm (88.5%) and 0.16 μm (11.5%).

The n-butyl acrylate content of the resin was 3.8 wt %.

The resin has a thermal stability of 16.8 minutes. The plastisol rheology indicated an eta 1.4 of 24.5 Pa·s. From the gelation curve, the viscosity of 10 kPa·s was reached at 76° C., while DSC indicated a Tg of 79.6° C.

### Example 1

The procedure of Comparative Example B was repeated except that the 300.7 g of n-butyl acrylate was introduced continuously to the polymerisation reactor between t0 and t0+7h00 instead of to the premixer.

The latex obtained had a pH of 8.4, a solid content of 46.4% and constituted of particles of 0.70 μm (88.1%) and 0.16 (11.9%).

The resin has a thermal stability of 22.2 minutes. The plastisol rheology indicated an eta 1.4 of 14.6 Pa·s. From the gelation curve, the viscosity of 10 kPa·s was reached at 71° C., while DSC indicated a Tg of 77.9° C.

These Examples show that the addition of n-butyl acrylate either in the premixer (Comparative Example B) or continuously (Example 1) results in a product with lower gelation temperature (shown by both the reduction in the temperature necessary to reach a viscosity of 10 kPa·s and by the reduction in Tg) compared to a PVC homopolymer. However this is at the expense of an increase in viscosity.

However, comparison of Example 1 shows that addition of the n-butyl acrylate continuously according to the present invention, compared to addition at or prior to the initial polymerisation commencing, results in further improved (further lowered) gelation temperature and also a lower viscosity.

### Comparative Example C

The procedure of Comparative Example B was repeated except that
i) 330.8 g of n-butyl acrylate was added to the premixer at the beginning of the process (during the first step, prior to connection to the polymerisation reactor),
ii) No PVC seed was added to the polymerisation reactor, and
iii) A different homogenizer was used. In particular a colloidal mill homogenizer was used and the mixture was recirculated 5 times with this operated at maximum speed.

The reaction time was slightly shorter than expected in this Comparative Example C, being about 6½ Hrs. (but, as Already Noted, was Above 7 Hours as Expected in the Following Examples 2 to 6.) Without wishing to be bound by theory, it is believed that consumption of the inhibitor and reaction of the n-butyl acrylate may have occurred during the heating period to reach the polymerization temperature before t0 in this Comparative Example.

The latex obtained had a pH of 9, a solid content of 49.8% and constituted of particles of 1.50 μm.

The n-butyl acrylate content of the resin was 4.3 wt %.

The plastisol rheology indicated an eta 1.4 of 16.2 Pa·s. From the gelation curve, the viscosity of 10 kPa·s was reached at 77.4° C.

### Example 2

The procedure of Comparative Example C was repeated except that the 330.8 g of n-butyl acrylate was introduced continuously to the polymerisation reactor between t0 and t0+7h00 instead of to the premixer.

The latex obtained had a pH of 8.6, a solid content of 46.2% and constituted of particles of 1.57 μm.

The plastisol rheology indicated an eta 1.4 of 4.7 Pa·s. From the gelation curve, the viscosity of 10 kPa·s was reached at 71° C., while DSC indicated a Tg of 75.1° C.

Comparison of Example 2 with Comparative Example C shows that addition of the n-butyl acrylate continuously according to the present invention, compared to addition at or prior to the initial polymerisation commencing again results in improved (lowered) gelation temperature and also a lower viscosity (eta 1.4).

### Examples 3 to 6

The procedure of Example 2 was repeated except using increase amounts of n-butyl acrylate (in each case added continuously between t0 and t0+7h00).

The effect on viscosity is shown below:

| | wt % n-butyl | | Gelation | |
|---|---|---|---|---|
| | acrylate in | eta 1.4 | temperature | Tg |
| Example | polymer | (Pa · s) | (° C.) | (° C.) |
| 3 | 6.4 | 4.0 | 71 | 75 |
| 4 | 7.2 | 6.7 | 66 | 73.4 |
| 5 | 8.6 | 14.4 | 54 | n.d. |
| 6 | 9.8 | 23.4 | 58 | 69.8 |

These Examples show further reductions in gelation temperature and Tg as the content of n-butyl acrylate increases.

These results also continue to show low viscosity (eta 1.4) by operating according to the present invention, albeit that the viscosity increases again as the content of n-butyl acrylate increases.

### Comparative Examples D and E, and Examples 7 and 8

These examples illustrate polymerisation under emulsion conditions.

### Comparative Example D

In this example vinyl chloride in polymerised under emulsion conditions, in the absence of comonomer.

Polymerisation was performed in a polymerisation reactor with a capacity of 25 L and equipped with a stirrer and a double jacket.

11.99 kg of water, 28.4 ml of a 2 g/L aqueous solution of copper sulfate pentahydrate, 79.3 g of a 110 g/L myristate solution (NaOH/NH₄OH ratio) were added to the reactor, which was then closed and the stirrer set to an agitation speed of 50 rpm. The reactor was purged of air by cycles of vacuum and nitrogen purges, before a final application of a vacuum. The agitation speed was increased to 160 rpm and 7.9 kg of vinyl chloride was loaded.

The temperature was raised to reach the polymerisation temperature (Tpol) of 52° C. using the double jacket. Once Tpol was reached, 45.1 ml of ammonia at 223 g/L followed 5 minutes later by 42.6 ml of ammonium persulfate at 100 g/L were introduced to start the polymerisation. This constitutes t0 in this Example.

At t0+0h20 continuous feeding of 110 g/L myristate solution (identical to that used at the beginning) was started. It was added continuously until t0+2h45 minutes after the start, corresponding to a total amount of 1257.9 g myristate solution. This was then stopped and continuous introduction of an aqueous solution of 48 g/kg sodium lauryl sulfate was then started and added until t0+4h00. The total amount of sodium lauryl sulfate aqueous solution added was 1056.3 g.

In addition, 2 injections, each of 789 g of vinyl chloride were injected at t0+1h30 and t0+2h30.

Once the pressure drop was detected (approx. 1 bar), 75.8 mL of 40 g/L sodium hydroxide solution was added and the temperature of the reactor was increased up to 80° C.

The pressure drop was observed/the reaction time was just over 4 hours, which is typical for reaction under these conditions.

The reactor was evacuated (with injection of 4.7 g of a commercial antifoam) and stripped of unreacted vinyl chloride (after addition of 2.5 ml of 223 g/L ammonia solution) over a period of 25 minutes. After stripping the reactor was cooled down to room temperature and 417 ml of 50 g/kg solution of sodium carbonate was added.

The latex was drained and the reactor cleaned.

The solid content of the latex and pH were 40.8% and 10.5, respectively. The latex was filtered through a sieve with a mesh size of 1 mm. The latex was dried on a spray dryer and the obtained resin was sieved and milled according to standard procedures. For the spray dryer, the inlet temperature is 160° C. and the outlet temperature is 70° C.

The DSC indicated a Tg of 79.9° C., and the resin had a gloss of 69GU.

The plastisol rheology indicated an eta 1.4 of 92 Pa·s, whilst the gelation temperature was 79° C.

### Comparative Example E

The process of Comparative Example D was repeated except that, in addition, 489.2 g of n-butyl acrylate was added at the beginning of the process with the first quantity of vinyl chloride. (Vinyl chloride was still added in a staged manner as described for Comparative Example D.) Reaction time was 4 hours.

The solid content of the latex and pH were 36.2% and 12.3, respectively. The latex was filtered, dried and milled as in Comparative Example D.

The n-butyl acrylate content of the resin was 4.6 wt %.

The DSC indicated a Tg of 75.9° C., and the resin had a gloss of 85GU.

The gelation temperature was 64° C., but the plastisol rheology indicated an eta 1.4 of only 6.7 Pa·s.

### Example 7

The procedure of Comparative Example D was repeated except that 295.5 g of n-butyl acrylate was introduced continuously to the polymerisation reactor between t0+0h30 and t0+4h00 (i.e. initially whilst introducing first the myristate solution and subsequently whilst introducing the lauryl sulfate aqueous solution). Reaction time was 4 hrs 35 minutes.

The solid content of the latex and pH were 40.9% and 10.4, respectively.

The n-butyl acrylate content of the resin was 3.8 wt %.

The DSC indicated a Tg of 72.1° C., and the resin had a gloss of 89GU.

The gelation temperature was 67° C., and the plastisol rheology indicated an eta 1.4 of 20 Pa·s.

Compared to Comparative Example D, therefore, a similar gelation temperature is obtained but at a much higher plastisol rheology. A lower Tg is also obtained.

### Example 8

The procedure of Example 7 was repeated except that 492.9 g of n-butyl acrylate was introduced continuously to the polymerisation reactor between t0+0h30 and t0+4h00. Reaction time was 5 hrs 19 minutes.

The solid content of the latex and pH were 39.0% and 10.3, respectively.

The n-butyl acrylate content of the resin was 4.9 wt %.

The DSC indicated a Tg of 70.5° C., and the resin had a gloss of 92GU.

The gelation temperature was 63° C., and the plastisol rheology indicated an eta 1.4 of 52 Pa·s.

Compared to Comparative Example D, therefore, again the process of the present invention results in a similar gelation temperature but at a much higher plastisol rheology. A lower Tg is again also obtained.

### Comparative Example F

This Comparative Example is a further Comparative Example provided to illustrate the effect of only adding n-butyl acrylate in the latter stages of the polymerisation. The polymerisation is performed under microsuspension conditions.

In particular, in a premixer autoclave with a capacity of 15 L and equipped with an agitator and a double jacket, 1.5 kg of water, 112.3 g of a 199.7 g/kg aqueous solution of sodium dodecylbenzenesulfonate, 3.9 g of dilauryl peroxide, 5.88 g of dimyristylperoxydicarbonate, 8.4 g of dioctyladipate and 0.03 g of butylated hydroxyanisole were added and mixed together at 50 rpm.

In the polymerization reactor with a capacity of 15 L and equipped with an agitator and a double jacket, 3.5 kg of water, 1.7 g of sodium carbonate, and 168.4 g of a 199.7 g/kg aqueous solution of sodium dodecylbenzenesulfonate and 572.7 g of 407.8 g/kg aqueous dispersion of a fine PVC seed were added and mixed together at 50 rpm.

Both reactors were linked together and closed to the atmosphere, a cycle of a vacuum followed by a nitrogen purge was applied, and finally a vacuum was applied and the agitation speed was increased to 250 rpm and 110 rpm for the premixer autoclave and the polymerization reactor, respectively. Afterwards, 2043.5 g and 3065.2 g of vinyl chloride was loaded to the premixer autoclave and the polymerization reactor, respectively.

A step of agitation of 30 minutes was maintained to ensure the mixing of all raw materials. Afterwards, the premixer autoclave agitation speed was reduced to 50 rpm and the premixer was connected to 2-stage high pressure homogenizer previously put under vacuum and the mixture was recirculated 5 minutes with the two stages pressures at 120 bars and 40 bars and then transferred to the polymerization autoclave.

Then, to rinse the premixer autoclave, and ensure the transfer of all reagents, 1 L of water was added to the premixer autoclave, agitated 3 minutes and transferred to the polymerization autoclave.

Upon completion of the transfer from the premixer autoclave, the polymerization autoclave temperature was raised to reach the polymerization temperature (Tpol) of 49° C. thanks to the double jacket. Once Tpol was reached, this defined the beginning of the polymerisation (t0).

From previous experiments under these conditions it was estimated that 50% conversion of vinyl chloride occurred at about 5 hours. Thus, in this experiment n-butyl acrylate addition was started 5 hours after initiation. More specifically, 312.5 g of n-butyl acrylate (with a purity of 997.5 g/kg) was introduced continuously between t0+5h00 and t0+7h00. 2 injections of 465 g of vinyl chloride were introduced in the autoclave at t0+2h00 and t0+3h00.

After 8 hours, the temperature of the polymerization medium was increased up to 80° C. It was then possible to evacuate (with injection of 2.8 g of a commercial antifoam) and strip the residual vinyl chloride from the autoclave. After stripping (25 minutes) the autoclave was cooled down to room temperature and drained.

The solid content of the latex (or latex density) and pH were measured. The latex was filtered through a sieve with a mesh size of 1 mm. The latex was dried on a spray dryer and the obtained resin was sieved and milled according to standard procedures. For the spray dryer, the inlet temperature is 160° C. and the outlet temperature is 60° C. The resin obtained was then milled in a Kolloplex 160Z (pin mill) at 14000 rpm.

The latex had a pH of 11.1 with a mechanical stability larger than 10 minutes, and the solid content was 43.2% constituted of particles of 0.54 μm (75.2%) and 0.18 (24.8%).

The resin has a thermal stability of 26.4 minutes, the 55 phr of DINP plastisol rheology indicated an eta 1.4 of 367 Pa·s. From the gelation curve, the viscosity of 10 kPa·s was reached at 76.0° C., while DSC indicated a Tg of 82.6° C.

The n-butyl acrylate content of the resin was 3.9 wt %.

As can be seen from the above, the “late addition” of n-butyl acrylate resulted in a product with a very high viscosity (eta 1.4), and also generally higher gelation temperature and Tg (° C.).

1. A process for the production of producing a vinyl chloride containing copolymer which process comprises:
a. Batch copolymerising in an emulsion polymerisation process, a mixture comprising vinyl chloride monomer (A) and a comonomer (B), wherein:
i. A weight ratio of A:B added to the polymerisation process is greater than 10:1 and such that the corresponding copolymer comprises less than 10 wt % comonomers,
ii. The comonomer (B) is added
1. continuously over at least 50% of a reaction time, or
2. in multiple additions and wherein initial and final additions are at least 50% of the reaction time apart, or
3. in a combination of 1 and 2 above,
b. After the reaction time,
i. increasing a temperature of the reaction mixture and
ii. stripping unreacted vinyl chloride over a period of at least 10 minutes, and
c. Recovering the vinyl chloride containing copolymer.

2. The process according to claim 1 wherein the addition of comonomer (B) is started no later than 1 hour after a start of the reaction time and/or no later than when 25% of the reaction time has elapsed.

3. The process according to claim 1 wherein the comonomer (B) is an alkyl (meth)acrylate.

4. The process according to claim 3 wherein the comonomer (B) is n-butyl acrylate.

5. The process according to claim 1 wherein the copolymer comprises 3 to 10 wt % comonomer (B).

6. The process according to claim 1 wherein the comonomer (B) is added continuously to the process over at least 50% of the reaction time.

7. A vinyl chloride-n-butyl acrylate copolymer which:
A) has a plastisol rheology measured at 23° C. 1.4 s⁻¹ according to ISO 3219 and ISO/TC61/N4710 of 24 Pa·s or less, and
B) has a gelation temperature, measured as a temperature at which a viscosity of 10,000 Pa·s is reached, of 76° C. or less,
wherein the plastisol rheology and gelation temperature are measured on a plastisol formed by mixing the copolymer with 55 parts per hundred of diisononyl phthalate.

8. The copolymer according to claim 7 wherein the plastisol rheology measured at 23° C. 1.4 s⁻¹ according to ISO 3219 and ISO/TC61/N4710 is 23 Pa·s or less.

9. The copolymer according to claim 7 wherein the gelation temperature, measured as the temperature at which a viscosity of 10,000 Pa·s is reached, is 74° C. or less.

10. A vinyl chloride-n-butyl acrylate copolymer which:
A) has a plastisol rheology measured at 23° C. 1.4 s⁻¹ according to ISO 3219 and ISO/TC61/N4710 of 20 Pa·s or more, and
B) has a gelation temperature, measured as a temperature at which a viscosity of 10,000 Pa·s is reached, of 76° C. or less,
wherein the plastisol rheology and gelation temperature are measured on a plastisol formed by mixing the copolymer with 100 parts per hundred of diisononyl phthalate.

11. The copolymer according to claim 10 wherein the plastisol rheology measured at 23° C. 1.4 s⁻¹ according to ISO 3219 and ISO/TC61/N4710 is 25 Pa·s or more.

12. The copolymer according to claim 10 wherein the gelation temperature, measured as the temperature at which a viscosity of 10,000 Pa·s is reached, is 74° C. or less.

13. The copolymer according to claim 10 wherein the copolymer has a gloss, measured according to ISO 2813, of at least 75GU (gloss units).

14. The copolymer according to claim 7 wherein the copolymer has a Tg (glass transition temperature), as determined by Differential Scanning calorimetry (DSC), of 80° C. or less.

15. The copolymer according to claim 7 wherein the copolymer comprises at least 3 wt % but less than 15 wt % n-butyl acrylate.

16. The copolymer according to claim 10 wherein the copolymer comprises at least 3 wt % but less than 15 wt % n-butyl acrylate.

17. (canceled)

18. A PVC product comprising the vinyl chloride-n-butyl acrylate copolymer produced according to the process of claim 1, wherein the PVC product is selected from the group consisting of: a flooring material, an automotive underbody coating, an adhesive and sealant material and an artificial leather material.

19. The copolymer according to claim 10 wherein the copolymer has a Tg (glass transition temperature), as determined by Differential Scanning calorimetry (DSC), of 80° C. or less.
